(19) United States
(12) Patent Application Publication
(10) Pub. No.: US 2021/0205813 A1
(43) Pub. Date: Jul. 8, 2021

(54) CONTACTLESS LIQUID LOADING TO MICROFLUIDIC DEVICES

(71) Applicant: NATIONAL TECHNOLOGY & ENGINEERING SOLUTIONS OF SANDIA, LLC, Albuquerque, NM (US)

(72) Inventors: Kosuke Iwai, Berkeley, CA (US); Jess Sustarich, San Francisco, CA (US); William Randy Gaillard, Walnut Creek, CA (US); Anup Kumar Singh, Danville, CA (US)

(21) Appl. No.: 17/130,861

(22) Filed: Dec. 22, 2020

Related U.S. Application Data
(60) Provisional application No. 62/953,147, filed on Dec. 23, 2019.

(51) Int. Cl. B01L 3/00

(52) U.S. Cl. CPC B01L 3/502784; B01L 2400/021; B01L 2300/165; B01L 2400/0424; B01L 2300/0645; B01L 2400/0427

(57) ABSTRACT

Disclosed herein include systems, devices, and methods for generating and directly loading droplets onto a microfluidic device with contactless delivery. Droplets can be generated and loaded onto a sealed microfluidic device through one or more connecting ports. Loaded droplets can be manipulated, such as merged.

### CROSS-REFERENCE TO RELATED APPLICATIONS

This application claims the benefit of priority to U.S. Provisional Patent Application No. 62/953,147, filed on Dec. 23, 2019, the content of which is incorporated herein by reference in its entirety.

### STATEMENT REGARDING FEDERALLY SPONSORED R&D

This invention was made with government support under grant no. DE-AC02-05CH11231 awarded by U.S. Department of Energy, Office of Science, Office of Biological and Environmental Research. The government has certain rights in the invention.

### BACKGROUND

### Field

The present disclosure relates generally to the field of sample analysis, for example sample loading for sample analysis.

### Description of the Related Art

There is a mismatch in the volume (e.g., in the order of microliters) that can be reproducibility introduced into microfluidic devices and chips and the volume that can be processed by microfluidic devices and chips (e.g., in the order of nanoliter and picoliter). Conventional methods to load liquid samples and reagents to microfluidic chips can require flowing samples and reagents with, for example, microliter volumes using a pump/syringe or pipetting and require additional steps to form smaller droplets (e.g., nanodroplets and picoliters) that can be processed in the microfluidic devices and chips. Smaller droplets can be formed by, for example, flow focusing. The mismatch in the volumes introduced and processed can result in large amounts of samples and reagents being wasted. The mismatch in the volumes introduced and processed has been a bottleneck for using microfluidic chips for high throughput screening applications.

### SUMMARY

Disclosed herein include embodiments of a method for sample analysis. In some embodiments, the method comprises: generating and directly loading a first plurality of droplets from a sample in a first liquid onto a surface of a microfluidic device (or chip) or a microfluidic channel thereof, or into a second liquid contained in the microfluidic device or a microfluidic channel thereof, using contactless delivery. The method can comprise: manipulating the first plurality of droplets. The method can comprise: analyzing manipulated droplets of the first plurality of droplets, or contents thereof, thereby analyzing the sample.

Disclosed herein include embodiments of a method for loading droplets and analyzing contents thereof. In some embodiments, the method comprises: generating and directly loading a first plurality of droplets, each (i) comprising an analyte, (ii) potentially comprising the analyte, (iii) potentially comprising one or more reaction partners of the analyte, or (iv) comprising one or more reaction partners of the analyte, onto a surface of a microfluidic device (or chip) or a microfluidic channel thereof, or into a second liquid contained in the microfluidic device or a microfluidic channel thereof, using contactless delivery. The method can comprise: manipulating the first plurality of droplets. The method can comprise: analyzing manipulated droplets of the first plurality of droplets, or contents thereof, thereby analyzing the analyte.

Disclosed herein include embodiments of a method for loading droplet and analyzing contents thereof. In some embodiments, the method comprises: generating and directly loading a first plurality of droplets from a first liquid onto a surface of a microfluidic device or a microfluidic channel thereof, or into a second liquid contained in the microfluidic device or a microfluidic channel thereof, using contactless delivery. The method can comprise: manipulating the first plurality of droplets. The method can comprise: analyzing manipulated droplets of the first plurality of droplets, or contents thereof, thereby analyzing the sample.

Disclosed herein include embodiments of a method for loading droplets and analyzing contents thereof. In some embodiments, the method comprises: generating and directly loading a first plurality of droplets onto a surface of a microfluidic device or a microfluidic channel thereof, or into a second liquid contained in the microfluidic device or a microfluidic channel thereof, using contactless delivery. One, at least one, or each of the first plurality of droplets can comprise a sample and/or a reagent. The method can comprise: manipulating the first plurality of droplets. The method can comprise: analyzing manipulated droplets of the first plurality of droplets, or contents thereof, thereby analyzing the sample and/or the reagent.

Disclosed herein include embodiments of a method for loading a sample. In some embodiments, the method comprises: generating and directly loading a first plurality of droplets from a sample in a first liquid onto a surface of a microfluidic device (or chip) or a surface of a microfluidic channel of the microfluidic device, or into a second liquid contained in the microfluidic device or the microfluidic channel of the microfluidic device, using contactless delivery.

In some embodiments, generating and directly loading the first plurality of droplets comprises generating and directly loading the first plurality of droplets onto the surface of the microfluidic device or a microfluidic channel thereof, or into the second liquid contained in the microfluidic device or a microfluidic channel thereof, through one or more connecting ports in a second substrate of the microfluidic device. Each of the one or more connecting ports can correspond to and/or can be for directing one or more of the first plurality of droplets to a first location of the microfluidic device and/or one of a first plurality of microfluidic channels of the microfluidic device. The one or more connecting ports can comprise at least 10 connecting ports. The one or more connecting ports can comprise an array of at least 10×10 connecting ports.

In some embodiments, generating and directly loading the first plurality of droplets comprise generating and directly loading the first plurality of droplets onto first locations on the surface of the microfluidic device or a microfluidic channel thereof. In some embodiments, generating and directly loading the first plurality of droplets comprise generating and directly loading the first plurality of droplets onto one or more first locations on the surface of each of a first plurality of microfluidic channels of the microfluidic device. In some embodiments, generating and directly loading the first plurality of droplets comprise generating and directly loading the first plurality of droplets to first locations, of the microfluidic device or a microfluidic channel thereof, comprising the second liquid. In some embodiments, generating and directly loading the first plurality of droplets comprise generating and directly loading the first plurality of droplets to one or more first locations of each of a first plurality of microfluidic channels of the microfluidic device comprising the second liquid. In some embodiments, generating and directly loading the first plurality of droplets comprise generating and directly loading the first plurality of droplets into the second liquid contained in the microfluidic device or a microfluidic channel thereof, thereby forming a first plurality of water-in-oil emulsions or oil-in-water emulsions.

In some embodiments, the first liquid comprises an aqueous solution and the second liquid comprises an oil and a surfactant. In some embodiments, the first liquid comprises an oil and a surfactant and the second liquid comprises an aqueous solution. In some embodiments, generating and directly loading the first plurality of droplets comprises generating and directly loading the first plurality of droplets from a source remote from the microfluidic device.

In some embodiments, a size of one, at least one, or each, of the first plurality of droplets is substantially the same as a size of the microfluidic channel. The size of one, at least one, or each, of the first plurality of droplets and the size of the microfluidic channel can be within one order of magnitude of each other. The size of one, at least one, or each, of the first plurality of droplets can comprise a diameter of the droplet of the first plurality of droplets. The size of the microfluidic channel can comprise a width and/or a height of the microfluidic channel. In some embodiments, the first plurality of microfluidic channels comprises at least 10 microfluidic channels.

In some embodiments, one of the first plurality of droplets has a volume of from about 1 picoliter (pl) to about 1 nanoliter (nl). In some embodiments, at least two of the first plurality of droplets comprise an identical volume, and/or at least two of the first plurality of droplets comprise different volumes. In some embodiments, the first locations comprise at least 10 first locations. In some embodiments, at least two of the first plurality of droplets are loaded onto, or to, one, at least one, or each, of the first locations. In some embodiments, an identical number of droplets of the first plurality of droplets are loaded onto, or to, at least two of the first locations, and/or different numbers of droplets of the first plurality of droplets are loaded onto, or to, at least two of the first locations.

In some embodiments, the method comprises sealing the microfluidic device or a microfluidic channel thereof and/or the surface of the microfluidic device or a microfluidic channel thereof with a second substrate.

In some embodiments, the contactless delivery comprises motion-controlled pin printing, nozzle-free printing (laser-induced forward transfer (LIFT) and acoustic), inkjet printing (piezoelectric and thermal), electrospray deposition (ESD), electrohydrodynamic (EHD) printing, and extrusion printing (pneumatic, piston, and screw), or a combination thereof.

In some embodiments, manipulating the first plurality of droplets comprises manipulating the first plurality of droplets using a pressure-driven manipulation. Manipulating the first plurality of droplets can comprise manipulating the first plurality of droplets using a flow-based manipulation (e.g., flow-based transportation). Manipulating the first plurality of droplets can comprise manipulating the first plurality of droplets using an electric field-based manipulation (e.g., electrowetting on dielectric (EWOD) or dielectrophoresis (DEP)). Manipulating the first plurality of droplets can comprise manipulating the first plurality of droplets using a digital microfluidic (DMF) manipulation (e.g., digital microfluidic mixing). In some embodiments, manipulating the first plurality of droplets comprises manipulating the first plurality of droplets or the first plurality of water-in-oil emulsions or oil-in-water emulsions directly. In some embodiments, manipulating the first plurality of droplets comprises physically manipulating the first plurality of droplets. In some embodiments, manipulating the first plurality of droplets comprises merging two of the first plurality of droplets. In some embodiments, manipulating the first plurality of droplets comprises merging one, at least one, or each, of the first plurality of droplets with a droplet of a second plurality of droplets.

In some embodiments, the method comprises loading a second plurality of droplets onto the surface of the microfluidic device or a microfluidic channel thereof, or into the second liquid contained in the microfluidic device or a microfluidic channel thereof. Loading the second plurality of droplets can comprise loading the second plurality of droplets onto the surface of the microfluidic device or a microfluidic channel thereof, or into the second liquid contained in the microfluidic device or a microfluidic channel thereof, through one or more connecting ports corresponding to one or more second locations of the microfluidic device or one or more first locations of each of a first plurality of microfluidic channels of the microfluidic device. The one or more first locations can comprise, or can be comprised in, the one or more second locations. Loading the second plurality of droplets can comprise generating and directly loading onto the surface of the microfluidic device or a microfluidic channel thereof, or into the second liquid contained in the microfluidic device or a microfluidic channel thereof using contactless delivery.

In some embodiments, manipulating the first plurality of droplets comprises manipulating the content of one, at least one, or each, of the first plurality of droplets. In some embodiments, manipulating the first plurality of droplets comprises performing a reaction on the content of the sample contained, or a portion thereof, in one, at least one, or each, of the first plurality of droplets. In some embodiments, manipulating the first plurality of droplets comprises performing a reaction on the content of the sample contained, or a portion thereof, in one, at least one, or each, of the first plurality of droplets using a reagent. The reaction can comprise a chemical reaction, a biological reaction, a biochemical reaction, a biophysical reaction, or a combination thereof.

In some embodiments, one, at least one, or each, of the first plurality of droplets potentially comprises an analyte, and one, at least one, or each, of the second plurality of droplets comprises one or more reaction partners of the analyte in the sample. In some embodiments, one, at least one, or each, of the first plurality of droplets comprises an analyte, and one, at least one, or each, of the second plurality of droplets potentially comprises one or more reaction partners of the analyte in the sample. In some embodiments, one, at least one, or each, of the first plurality of droplets comprises a reagent, and one, at least one, or each of the second plurality of droplets comprises a cell. In some embodiments, one, at least one, or each, of the first plurality of droplets comprises a cell, and one, at least one, or each of the second plurality of droplets comprises a reagent.

The reagent can comprise a barcoding reagent. The barcoding reagent can comprise a bead. The barcoding reagent can comprise a plurality of barcodes. The bead can comprise the plurality of barcodes. The plurality of barcodes can be attached to the bead. The plurality of barcodes can be reversibly attached to the bead. The plurality of barcodes can be released from the bead using a stimulus. The stimulus can comprise a chemical stimulus, a physical stimulus, a biological stimulus, a thermal stimulus, a magnetic stimulus, an electric stimulus, a light stimulus, or a combination thereof. One, at least one, or each of the plurality of barcodes can comprise a molecular label, a cell label, a first target binding sequence, and/or a universal sequence. The molecular label can be 2-40 nucleotides in length. The cell label can be 2-40 nucleotides in length. The first target binding sequence can be 2-40 nucleotides in length. The universal sequence can be 2-40 nucleotides in length, Two barcodes of the plurality of barcodes can comprise cell labels with an identical cell label sequence. Cell labels of two barcodes of different barcoding reagents can comprise different cell label sequences. Two barcodes of the plurality of barcodes can comprise molecular labels with different molecular label sequences. Molecular labels of two barcodes of different barcoding reagents can comprise an identical molecular label sequence. The first target binding sequences can comprise a poly(dT) sequence. The first target binding sequence can comprise a repeat sequence of A, T, G, or C. The repeat sequence can comprise AA, TT, GG, or CC. The barcoding reagent can comprise a plurality of oligonucleotides or polynucleotides each with a second target binding sequence. The second target binding sequences comprises a poly(dT) sequence. The bead can comprise the plurality of oligonucleotides or polynucleotides. The plurality of oligonucleotides or polynucleotides can be attached to the bead. The plurality of oligonucleotides or polynucleotides can be reversibly attached to the bead. The plurality of oligonucleotides or polynucleotides can be released from the bead using a stimulus. The second target binding sequence can be 2-40 nucleotides in length.

In some embodiments, analyzing the manipulated droplets comprises performing gene expression analysis, genotyping, real time polymerase chain reaction (PCR), digital PCR, targeted sequencing, single-cell genomics analysis, sample identification, Ag-genomics analysis, single cell analysis, single-cell proteomics analysis, single cell messenger ribonucleic acid (mRNA) sequencing, microRNA analysis, single cell deoxyribonucleic acid (DNA) sequencing, next generation sequencing, single cell targeted gene expression, RNA sequencing, single cell functional genomics, nucleic acid absolute quantification, copy number variation determination, loss of heterozygosity analysis, genetic alteration or modification detection, rare sequence or mutation detection, genome edit detection, drug metabolism analysis, or a combination thereof. In some embodiments, analyzing the manipulated droplets or contents thereof comprises obtaining mass spectrums of the manipulated droplets or contents thereof.

In some embodiments, the sample comprises a clinical sample, a biological sample, a chemical sample, a soil sample, an air sample, an environmental sample, a cell culture sample, a bone marrow sample, a rainfall sample, a fallout sample, a sewage sample, a ground water sample, an abrasion sample, an archaeological sample, a food sample, a blood sample, a serum sample, a plasma sample, a urine sample, a stool sample, a semen sample, a lymphatic fluid sample, a cerebrospinal fluid sample, a nasopharyngeal wash sample, a sputum sample, a mouth swab sample, a throat swab sample, a nasal swab sample, a bronchoalveolar lavage sample, a bronchial secretion sample, a milk sample, an amniotic fluid sample, a biopsy sample, a cancer sample, a tumor sample, a tissue sample, a cell sample, a cell culture sample, a cell lysate sample, a virus culture sample, a nail sample, a hair sample, a skin sample, a forensic sample, an infection sample, a nosocomial infection sample, a production sample, a drug preparation sample, a biological molecule production sample, a deoxyribonucleic acid (DNA) sample, a protein sample, a sample, a carbohydrate sample, a metabolite sample, a space sample, an extraterrestrial sample or a combination thereof .

In some embodiments, the analyte comprises one or more of a protein, a nucleic acid, a lipid, a carbohydrate, a chemical, a cell, or a combination thereof. In some embodiments, the one or more potential reaction partners comprise one or more of proteins, nucleic acids, lipids, carbohydrates, chemicals, cells, or a combination thereof. In some embodiments, the analyte and/or the one or more potential reaction partners comprise drugs, enzymes, antibodies, immunogens, antigens, metabolites, antibiotics, chemicals, microbial cells, or a combination thereof. In some embodiments, the one or more potential reaction partners of the analyte comprise one or more potential substrates of an enzyme, and the analyte comprises an enzyme. The enzyme can be capable of catalyzing one substrate of the one or more potential substrates to a product. In some embodiments, the one or more potential reaction partners of the analyte comprise one or more enzymes potentially capable of catalyzing a substrate to a product, and the analyte comprises the substrate. One enzyme of the one or more enzymes potentially capable of catalyzing the substrate to the product can be capable of catalyzing the substrate to the product. The substrate can be a drug, and the enzyme can be capable of metabolizing the drug to the product.

In some embodiments, the analytes and/or potential reaction partners of droplets of the first plurality of droplets comprise different DNA constructs, a first plasmid, enzymes and/or cells, and wherein the different DNA constructs together with the first plasmid, the enzymes and/or the cells assemble the DNA constructs into second plasmids capable of transforming the cells. The analyte can comprise a first chemical, the one or more potential reaction partners can comprise a second chemical, and the first chemical and the second chemical react to form one or more products. The analyte and/or the one or more potential reaction partners can comprise a DNA molecule and drugs that interact with the DNA molecule, respectively. The analyte and/or the one or more potential reaction partners can comprise a protein molecule and drugs that interact with the protein molecule, respectively.

In some embodiments, at least two of the droplets from the first plurality of droplets comprise one potential reaction partner in different concentrations or comprise different buffer conditions. At least two of the droplets from the second plurality of droplets can comprise the analyte in different concentrations or comprise different buffer conditions.

In some embodiments, the microfluidic device comprises a first substrate, one or more first electrodes in contact with the first substrate, a dielectric layer in contact with the first substrate and the first electrodes, a first hydrophobic coating in contact with the first dielectric layer, a second substrate, one or more second electrodes in contact with the second substrate and a second hydrophobic coating, the second hydrophobic coating, a spacer layer in contact with the first substrate, the first dielectric layer, the first hydrophobic layer, the second substrate, the one or more second electrodes, and/or the second hydrophobic coating.

Disclosed herein include embodiments of a microfluidic device for sample analysis, loading droplets, and/or loading a sample of the present disclosure.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1 is a non-limiting exemplary schematic illustration showing dispensing droplets onto a microfluidic device or chip under air environment.

FIGS. 2A-2C are non-limiting exemplary schematic illustrations showing dispensing droplets onto a microfluidic device or chip with oil environment. The device can be sealed after the dispensing process.

FIG. 3 is a non-limiting exemplary schematic illustration showing dispensing droplets onto a microfluidic device with oil environment via access ports.

FIG. 4 is a photograph showing a non-limiting exemplary fabricated microfluidic device with connecting ports providing access to microfluidic channels with a loading holder. The inset on the left shows a microfluidic channel (dashed circle) and the connecting port providing access to the microfluidic channel enlarged.

FIG. 5A-5B are non-limiting exemplary photographs showing aqueous sample loading with an acoustic printer directly into an oil phase (FIG. 5A) and into an open channel (FIG. 5B). FIG. 5A shows that droplets were separated when the channel was pre-filled with an oil phase with a surfactant. Different volumes (25 nl, 50 nl, and 100 nl) of samples with different colors were loaded via a connecting port. FIG. 5B shows that when the channel was open without an oil phase, droplets were merged immediately after loading, and the merged droplets evaporated quickly due to the high surface-volume ratio.

FIG. 6A is a non-limiting exemplary photograph showing loaded droplets before merging. FIG. 6B is non-limiting exemplary photograph showing merging of loaded droplets by applying voltage to digital microfluidics (DMF) electrodes.

FIGS. 7A-7F are non-limiting exemplary photographs showing components of a microfluidic device. FIG. 7E is a non-limiting exemplary photograph showing a microfluidic device assembled from the components shown in FIGS. 7A-7E. FIG. 7F is a non-limiting exemplary photograph showing samples loaded to a microfluidic device through connecting ports.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

Disclosed herein include embodiments of a method for sample analysis. In some embodiments, the method comprises: generating and directly loading a first plurality of droplets from a sample in a first liquid onto a surface of a microfluidic device (or chip) or a microfluidic channel thereof, or into a second liquid contained in the microfluidic device or a microfluidic channel thereof, using contactless delivery (e.g., contactless jetting). The method can comprise: manipulating the first plurality of droplets. The method can comprise: analyzing manipulated droplets of the first plurality of droplets, or contents thereof, thereby analyzing the sample.

Disclosed herein include embodiments of a method for loading droplets. In some embodiments, the method comprises: generating and directly loading a first plurality of droplets, each (i) comprising an analyte, (ii) potentially comprising the analyte, or (iii) comprising one or more potential reaction partners of the analyte, onto a surface of a microfluidic device (or chip) or a microfluidic channel thereof, or into a second liquid contained in the microfluidic device or a microfluidic channel thereof, using contactless delivery or jetting. The method can comprise: manipulating the first plurality of droplets. The method can comprise: analyzing manipulated droplets of the first plurality of droplets, or contents thereof, thereby analyzing the analyte.

Disclosed herein include embodiments of a method for loading droplet and analyzing contents thereof. In some embodiments, the method comprises: generating and directly loading a first plurality of droplets from a first liquid onto a surface of a microfluidic device or a microfluidic channel thereof, or into a second liquid contained in the microfluidic device or a microfluidic channel thereof, using contactless delivery. The method can comprise: manipulating the first plurality of droplets. The method can comprise: analyzing manipulated droplets of the first plurality of droplets, or contents thereof, thereby analyzing the sample.

Disclosed herein include embodiments of a method for loading droplets and analyzing contents thereof. In some embodiments, the method comprises: generating and directly loading a first plurality of droplets onto a surface of a microfluidic device or a microfluidic channel thereof, or into a second liquid contained in the microfluidic device or a microfluidic channel thereof, using contactless delivery. One, at least one, or each of the first plurality of droplets can comprise a sample and/or a reagent. The method can comprise: manipulating the first plurality of droplets. The method can comprise: analyzing manipulated droplets of the first plurality of droplets, or contents thereof, thereby analyzing the sample and/or the reagent.

Disclosed herein include embodiments of a method for loading a sample. In some embodiments, the method comprises: generating and directly loading a first plurality of droplets from a sample in a first liquid onto a surface of a microfluidic device (or chip or a surface of a microfluidic channel of the microfluidic device, or into a second liquid contained in the microfluidic device or the microfluidic channel of the microfluidic device, using contactless delivery or jetting.

Unless defined otherwise, technical and scientific terms used herein have the same meaning as commonly understood by one of ordinary skill in the art to which the present disclosure belongs. See, e.g., Singleton et al., Dictionary of Microbiology and Molecular Biology 2nd ed., J. Wiley & Sons (New York, N.Y. 1994); Sambrook et al., Molecular Cloning, A Laboratory Manual, Cold Spring Harbor Press (Cold Spring Harbor, N.Y. 1989).

### Contactless Droplet Loading to a Microfluidic Chip

Disclose herein include systems, devices, and methods for contactless loading of a sample, one or more analytes, one or more reaction partners of an analyte or analytes, and/or a reagent, to a microfluidic chip. In some embodiments, contactless delivery (e.g., contactless jetting) is used to generate droplets (e.g., microdroplets, nanodroplets, or picodroplets) on demand in the same size scale of the volumes required for microfluidic devices or chips. The droplets generated can be directly loaded onto microfluidic devices or chips. Additional steps of dispensing the desired sized droplets (e.g., in the order of nanoliter and picoliter) on the microfluidic devices or chips when larger volumes of liquids (e.g., in the order of microliter) are loaded onto the microfluidic devices or chips used by conventional methods can be eliminated. Generating and directly loading the droplets using contactless delivery or jetting can significantly reduce the processes and costs when loading numbers of different liquid samples, analytes, reaction partners, and/or analytes. In some embodiments, the droplets are loaded into an oil phase (e.g., hydrofluoroethers (HFE), and hexadecane) in a microfluidic device or chip. The oil phase can prevent the evaporation of the aqueous samples and keeps the droplets from merging. The jetted droplets can be readily be manipulated (e.g., moved around) by electrodes on the chip to enable high-throughput assays. In addition to saving on the costs of reagents and samples, generating and directly loading the droplets using contactless delivery can provide simplicity and significant cost reduction by not requiring construction of separate microliter-sized sample reservoirs interfaced with the chip.

Droplets with the same size scale of a microfluidic channel (e.g., picoliter, nanoliter, or microliter) can be dispensed onto the substrates (e.g., glass, polydimethylsiloxane (PDMS), and printed circuit board (PCB)) of a microfluidic device remotely from the sample source. Non-limiting examples of contactless delivery or jetting include acoustic printer, electrospray, droplet injector, coaxial capillary dispenser, laser-induced forward transfer, piezoelectric inkjet printer, electrospray deposition, electrohydrodynamic printer, extrusion printers. The droplets can be dispensed directly targeting onto a microfluidic device in air environment or oil environment. The microfluidic device can be sealed after the loading processes. The droplets can be loading onto a microfluidic device through one or more connecting ports. As the dispensed droplets are in the same size scale of the microfluidic channels, droplets can be manipulated immediately (without extra steps of droplet formation) with microfluidic liquid handling methods such as flow-based transportation or digital microfluidics mixing. The systems, devices, and methods disclosed herein can enable high-throughput loading of numbers of different types of samples onto microfluidic devices in a programmable manner.

One advantage of microfluidics is the ability to conduct a large number of assays and reactions in parallel using very small volumes. Conducting a large number of assays and reactions, such as high-throughput screening, requires inputting a large number of samples into sample reservoirs of a microfluidic device chip. Inputting a large number of samples can be done by pipetting, manually or robotically, from a microtiter plate. Inputting a large number of samples can be done with wells fabricated in the housing or cartridge holding the microfluidic device or chip. Such formats require large volumes of starting sample because volumes smaller than 1-2 μl cannot be pipetted consistently with pipettors. Moreover, loss by evaporation also becomes an issue for very small volume reservoirs. Hence, while microfluidic devices and chips can process nanoliter and picoliter volumes, samples and reagents are typically introduced in microliter volumes, leading to waste of precious samples and reagents. Inputting a large number of samples using convention microfluidics methods and devices also require microfluidic devices or chips to be interfaced to a much larger footprint sample introduction device.

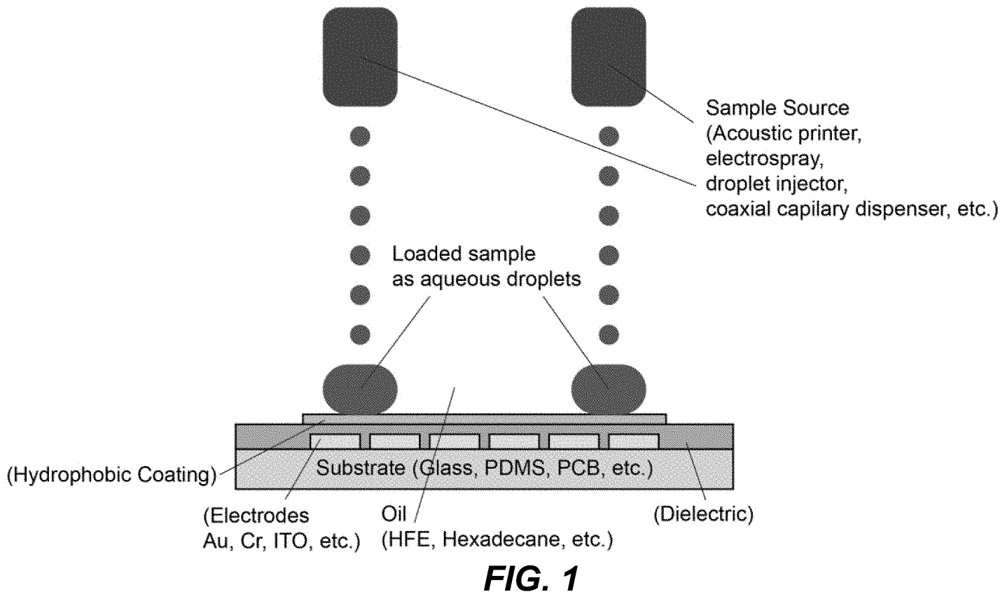

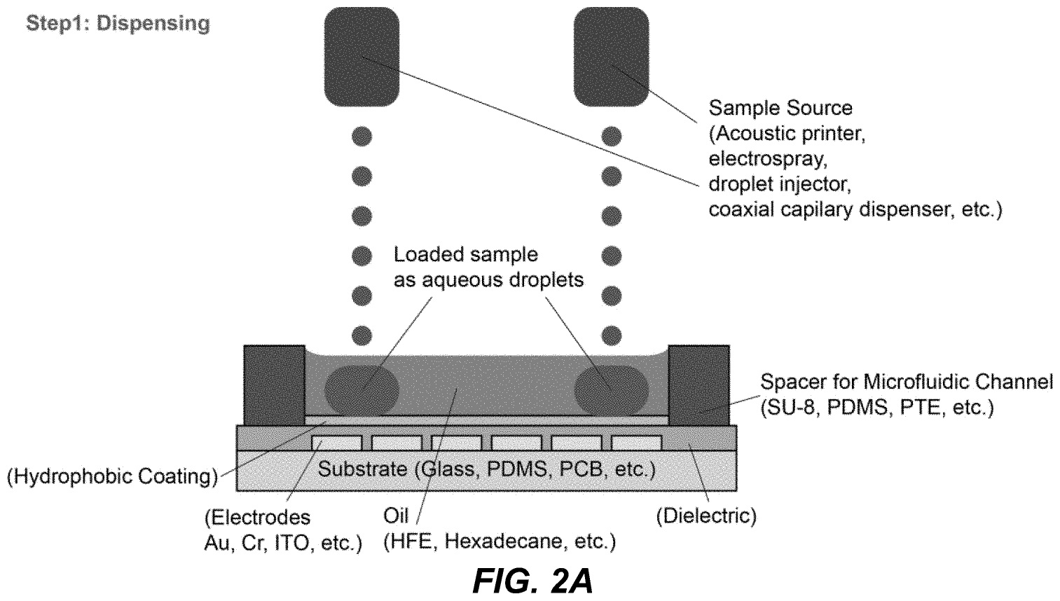

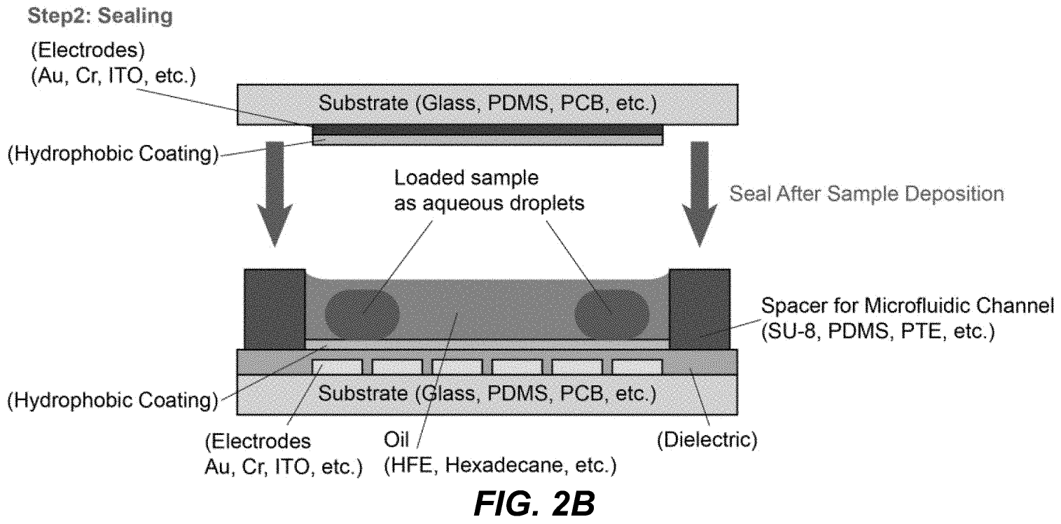

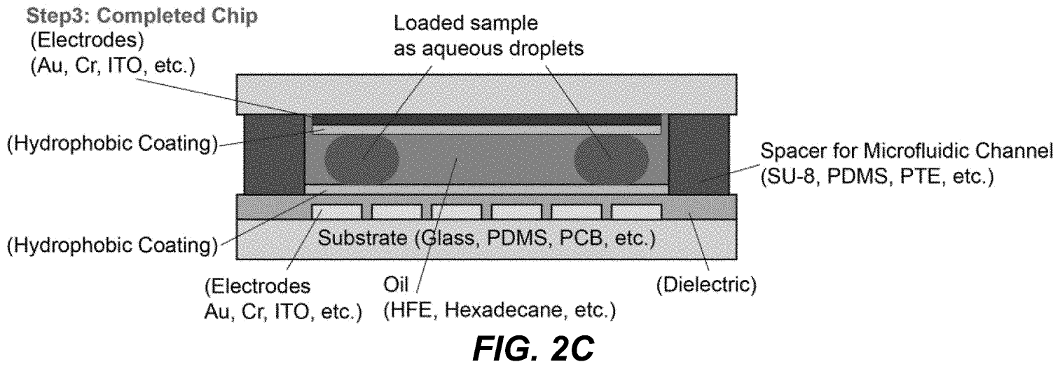

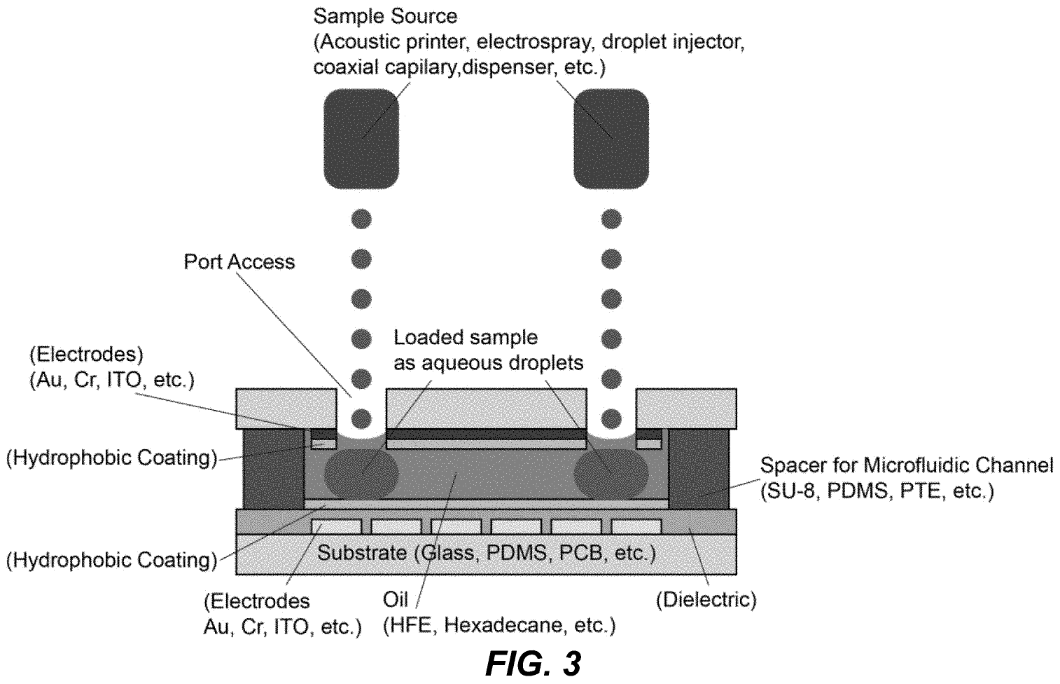

The systems, devices, and methods disclosed herein can enable loading picoliter to nanoliter samples (e.g., aqueous samples) and reagents into microfluidic devices using contactless delivery or jetting of droplets. Picoliter or nanoliter droplets can be dispensed onto a microfluidic device or chip. In some embodiments, the microfluidic device or chip contains an oil (or another water-immiscible fluid) and the injected aqueous droplets are enveloped in the oil. The injected droplets being enveloped in the oil can avoid evaporative loss and keep the droplets from mixing with other droplets. The contactless injection or jetting can be done from a sample source by one of many methods including acoustic, ultrasonic, electrospray, hydrodynamic (e.g., coaxial capillary dispenser), laser-induced forward transfer, piezoelectric, electrohydrodynamic or extrusion. Dispensing can be directly targeting onto the microfluidic device or chip in air environment (FIG. 1) or oil environment (FIG. 2A), which can be sealed after the loading processes (FIGS. 2B-2C). Dispending can be loading droplets through connecting ports of a pre-sealed microfluidic device (FIG. 3). As the dispensed droplets are in the same size scale of one or more microfluidic channels of the microfluidic device or chip, droplets can be manipulated immediately (without extra steps of droplet formation) with microfluidic liquid handling methods such as flow-based transportation or digital microfluidic mixing. The systems, devices, and methods disclosed herein can enable high-throughput loading of numbers of different types of samples onto microfluidic devices in a programmable manner.

Generating and directly loading droplets into or onto a microfluidic device using contactless delivery does not require complicated tubing and/or pipetting, thus is scalable. Generating and directly loading droplets into or onto a microfluidic device using contactless delivery does not require droplets to be dispensed or formed on a microfluidic device, thus is faster. Generating and directly loading aqueous droplets into or onto an oil phase a microfluidic device using contactless delivery, or vice versa, can prevent droplet evaporation and contamination.

The contactless delivery or jetting process of the present disclosure can be used for generating and directly loading droplets onto microfluidic devices. The contactless delivery or jetting process of the present disclosure can be used for generating and directly loading droplets onto microfluidic devices for synthetic biology experiments. Embodiments of the microfluidic device and use thereof can be used to build picoliter and nanoliter dispensing devices. Embodiments of the microfluidic device or use thereof can include droplet microfluidics for genomic and sequencing sample preparation and analysis. The microfluidic device can be used for high throughput sample introduction.

Disclosed herein include embodiments of a method for sample analysis. In some embodiments, the method comprises: generating and directly loading (e.g., dispensing) a first plurality of droplets from a sample in a first liquid (e.g., an aqueous liquid) onto a surface of a microfluidic device (or chip) or a microfluidic channel thereof, or into a second liquid (e.g., an oil, such as hydrofluoroethers (HFE) or hexadecane with a surfactant) contained in the microfluidic device or a microfluidic channel thereof, using contactless delivery (See FIG. 2A for an example). The first plurality of droplets can be generated and then directly (e.g., immediately) loaded onto a surface of a microfluidic device, or into a second liquid contained in the microfluidic device or a microfluidic channel thereof, without any additional manipulation, such as droplet formation. The sample can include an analyte, a potential analyte, a reaction partner of an analyte, and/or a potential reaction partner of an analyte. The method can comprise: manipulating the first plurality of droplets. The method can comprise: analyzing manipulated droplets of the first plurality of droplets, or contents thereof, thereby analyzing the sample.

Disclosed herein include embodiments of a method for loading droplets. In some embodiments, the method comprises: generating and directly loading (e.g., dispensing) a first plurality of droplets comprising a first liquid (e.g., a first phase, such an aqueous phase) onto a surface of a microfluidic device (or chip) or a microfluidic channel thereof, or into a second liquid (e.g., a second phase, such as an oil phase) contained in the microfluidic device or a microfluidic channel thereof, using contactless delivery (See FIG. 2A for an example). The first plurality of droplets can be generated and then directly (e.g., immediately) loaded onto a surface of a microfluidic device, or into a second liquid contained in the microfluidic device or a microfluidic channel thereof, without any additional manipulation, such as droplet formation. One, at least one, or each, of the first plurality of droplets can comprise an analyte. One, at least one, or each, of the first plurality of droplets can comprise a potential analyte. One, at least one, or each, of the first plurality of droplets can potentially comprise an analyte. One, at least one, or each, of the first plurality of droplets can comprise one or more reaction partners of an analyte. One, at least one, or each, of the first plurality of droplets can comprise one or more potential reaction partners of an analyte. One, at least one, or each, of the first plurality of droplets can comprise one or more reagents of a reaction. The reaction can include a reaction partner catalyzing the analyte (e.g., a substrate) into a product. The reaction can include an analyte converting a reaction partner (e.g., a substrate) into a product. One, at least one, or each, of the first plurality of droplets can potentially comprise one or more reaction partners of an analyte. The method can comprise: manipulating the first plurality of droplets. The method can comprise: analyzing manipulated droplets of the first plurality of droplets, or contents thereof, thereby analyzing the analyte.

Disclosed herein include embodiments of a method for loading droplet and analyzing contents thereof. In some embodiments, the method comprises: generating and directly loading a first plurality of droplets from a first liquid onto a surface of a microfluidic device or a microfluidic channel thereof, or into a second liquid contained in the microfluidic device or a microfluidic channel thereof, using contactless delivery. The method can comprise: manipulating the first plurality of droplets. The method can comprise: analyzing manipulated droplets of the first plurality of droplets, or contents thereof, thereby analyzing the sample. The first plurality of droplets and/or the first liquid can comprise one or more analytes, one or more reaction partners of an analyte, one or more reagents, and/or one or more samples.

Disclosed herein include embodiments of a method for loading droplets and analyzing contents thereof. In some embodiments, the method comprises: generating and directly loading (e.g., dispensing) a first plurality of droplets onto a surface of a microfluidic device or a microfluidic channel thereof, or into a second liquid contained in the microfluidic device or a microfluidic channel thereof, using contactless delivery. One, at least one, or each of the first plurality of droplets can comprise a sample and/or a reagent. The method can comprise: manipulating the first plurality of droplets. The method can comprise: analyzing manipulated droplets of the first plurality of droplets, or contents thereof, thereby analyzing the sample and/or the reagent.

Disclosed herein include embodiments of a method for loading a sample. In some embodiments, the method comprises: generating and directly loading (or dispensing) a first plurality of droplets from a sample in a first liquid onto a surface of a microfluidic device (or chip) or a surface of a microfluidic channel of the microfluidic device, or into a second liquid contained in the microfluidic device or the microfluidic channel of the microfluidic device, using contactless delivery. The first plurality of droplets can be generated and then directly (e.g., immediately) loaded onto a surface of a microfluidic device or a surface of a microfluidic channel of the microfluidic device without any additional manipulation, such as droplet formation. The sample can include an analyte, a potential analyte, a reaction partner of an analyte, and/or a potential reaction partner of an analyte.

### Generating and Directly Loading Droplets

In some embodiments, generating and directly loading the first plurality of droplets comprises generating and directly loading the first plurality of droplets from a source (e.g., a sample source, an analyte source, a reaction partner source, or a reagent source) remote from the microfluidic device. In some embodiments, generating and directly loading the first plurality of droplets comprise generating and directly loading the first plurality of droplets onto first locations on the surface of the microfluidic device or a microfluidic channel thereof. Each location can be a microfluidic channel. Each location can be a reaction chamber. A microfluidic channel can include one or more locations. In some embodiments, generating and directly loading the first plurality of droplets comprise generating and directly loading the first plurality of droplets onto one or more first locations on the surface of each of a first plurality of microfluidic channels of the microfluidic device.

The number of droplets of the first plurality of droplets generated and/or directly loaded can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, or a number or a range between any two of these values. The number of droplets of the first plurality of droplets loaded onto a first location can be, be about, be at least, or be at most, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values.

An identical number of droplets of the first plurality of droplets can be loaded onto, or to, at least two of the first locations. The number of first locations loaded with an identical number of droplets of the first plurality of droplets can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values. Different numbers of droplets of the first plurality of droplets can be loaded onto, or to, at least two of the first locations. The number of first locations loaded with different numbers of droplets of the first plurality of droplets can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values. The number of first locations can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values.

In some embodiments, generating and directly loading the first plurality of droplets comprise generating and directly loading the first plurality of droplets to first locations, of the microfluidic device or a microfluidic channel thereof, comprising the second liquid (e.g., an oil phase; See FIGS. 2A and 3 for examples). In some embodiments, generating and directly loading the first plurality of droplets comprise generating and directly loading the first plurality of droplets to one or more first locations of each of a first plurality of microfluidic channels of the microfluidic device comprising the second liquid. One, at least one, or each of the first plurality of microfluidic channels can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values, first locations the generated droplets of the first plurality of droplets are directed loaded onto. In some embodiments, generating and directly loading the first plurality of droplets comprises generating and directly loading the first plurality of droplets into the second liquid contained in the microfluidic device or a microfluidic channel thereof, thereby forming a first plurality of water-in-oil emulsions (See FIGS. 2A and 3 for examples) or oil-in-water emulsions.

### Manipulating Droplets

In some embodiments, manipulating the first plurality of droplets comprises manipulating the first plurality of droplets using a pressure-driven manipulation. Manipulating the first plurality of droplets can comprise manipulating the first plurality of droplets using a flow-based manipulation (e.g., flow-based transportation). Manipulating the first plurality of droplets can comprise manipulating the first plurality of droplets using an electric field-based manipulation (e.g., electrowetting on dielectric (EWOD) or dielectrophoresis (DEP)). Manipulating the first plurality of droplets can comprise manipulating the first plurality of droplets using a digital microfluidic (DMF) manipulation (e.g., digital microfluidic mixing),In some embodiments, manipulating the first plurality of droplets comprises manipulating the first plurality of droplets or the first plurality of water-in-oil emulsions or oil-in-water emulsions directly. In some embodiments, manipulating the first plurality of droplets comprises physically manipulating the first plurality of droplets. In some embodiments, manipulating the first plurality of droplets comprises merging two of the first plurality of droplets. In some embodiments, manipulating the first plurality of droplets comprises merging one, at least one, or each, of the first plurality of droplets with a droplet of a second plurality of droplets. One, at least one, or each, of the second plurality of droplets can comprise one or more potential reaction partners of an analyte in the sample.

In some embodiments, manipulating the first plurality of droplets comprises manipulating the content of one, at least one, or each, of the first plurality of droplets. In some embodiments, manipulating the first plurality of droplets comprises performing a reaction on the content of the sample contained, or a portion thereof, in one, at least one, or each, of the first plurality of droplets using a reagent. The reaction can comprise a chemical reaction, a biological reaction, a biochemical reaction, a biophysical reaction, or a combination thereof.

### Loading Additional Droplets

In some embodiments, the method comprises loading a second plurality of droplets onto the surface of the microfluidic device or a microfluidic channel thereof, or into the second liquid contained in the microfluidic device or a microfluidic channel thereof. The number of second plurality of droplets loaded can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, or a number or a range between any two of these values.

Loading the second plurality of droplets can comprise loading the second plurality of droplets onto the surface of the microfluidic device or a microfluidic channel thereof, or into the second liquid contained in the microfluidic device or a microfluidic channel thereof, through one or more connecting ports corresponding to one or more second locations of the microfluidic device or one or more first locations of each of a first plurality of microfluidic channels of the microfluidic device. The one or more first locations can comprise, or can be comprised in, the one or more second locations. Loading the second plurality of droplets can comprise generating and directly loading onto the surface of the microfluidic device or a microfluidic channel thereof, or into the second liquid contained in the microfluidic device or a microfluidic channel thereof using contactless delivery (e.g., contactless jetting).

An identical number of droplets of the second plurality of droplets can be loaded onto, or to, at least two of the second locations. The number of second locations loaded with an identical number of droplets of the second plurality of droplets can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values. Different numbers of droplets of the second plurality of droplets can be loaded onto, or to, at least two of the second locations. The number of second locations loaded with different numbers of droplets of the second plurality of droplets can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values. The number of second locations can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values.

### Microfluidic Device

Embodiments of a microfluidic device or chip for sample analysis, loading droplets, and/or loading a sample of the present disclosure can comprise a first substrate (e.g., glass, PDMS, or PCB), one or more first electrodes or a first electrode layer (e.g., Au, Cr, or indium tin oxide (ITO)) in contact with the first substrate, a dielectric layer in contact with the first substrate and the one or more first electrodes or first electrode layer, and a first hydrophobic coating in contact with the dielectric layer (See FIGS. 1, 2A, and 3 for examples). The dielectric layer can comprise the one or more first electrodes. The microfluidic device can comprise, comprise about, comprise at least, or comprise at most, 1, 2, 3, 4, 5, 6, 7, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, first electrodes. The microfluidic device can include a microfluidic chip. The microfluidic device can be a microfluidic chip.

The microfluidic device can comprise a second substrate (e.g., glass, PDMS, or PCB), one or more second electrodes or a second electrode layer (e.g., Au, Cr, or indium tin oxide (ITO)) in contact with the second substrate and a second hydrophobic coating, and the second hydrophobic coating (See FIGS. 2A-2C and 3 for examples). The microfluidic device can comprise, comprise about, comprise at least, or comprise at most, 1, 2, 3, 4, 5, 6, 7, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, second electrodes.

The microfluidic device can comprise a spacer layer in contact with the first substrate, the first dielectric layer, the first hydrophobic layer, the second substrate, the one or more second electrodes, and/or the second hydrophobic coating (See FIGS. 2A-2C and 3 for examples). The microfluidic device can comprise a spacer layer in contact with the first substrate, the first dielectric layer, and the first hydrophobic layer in an unsealed configuration (See FIG. 2A for an example). The microfluidic device can be sealed using a sealing component, which can include the second substrate, the one or more second electrodes, and the second hydrophobic coating. The microfluidic device can comprise the spacer layer in contact with the first substrate, the first dielectric layer, the first hydrophobic layer, the second substrate, the one or more second electrodes, and the second hydrophobic coating in a sealed configuration (See FIGS. 2A-2C and 3 for examples).

Components of the microfluidic device can be made using photolithography, stencil cutting, Computer Numerical Control (CNC) milling, and/or three-dimensional (3D) printing. For example, electrodes can be made using photolithography. For example, the spacer layer, or components of the spacer layer, can be made using stencil cutting, CNC milling, and/or 3D printing.

Connecting Ports

In some embodiments, generating and directly loading the first plurality of droplets comprises generating and directly loading the first plurality of droplets onto the surface of the microfluidic device or a microfluidic channel thereof, or into the second liquid contained in the microfluidic device or a microfluidic channel thereof, through one or more connecting ports in a second substrate of the microfluidic device (See FIG. 3 for an example). Each of the one or more connecting ports can correspond to one or more of the first plurality of droplets to a first location of the microfluidic device. Each of the one or more connecting ports can correspond to one of a first plurality of microfluidic channels of the microfluidic device. Each of the one or more connecting ports can correspond to one of a first plurality of reaction chambers of the microfluidic device. Each of the one or more connecting ports can be for directing one or more of the first plurality of droplets to a first location of the microfluidic device. Each of the one or more connecting ports can be for directing one of a first plurality of microfluidic channels of the microfluidic device. Each of the one or more connecting ports can be for directing one of a first plurality of reaction chambers of the microfluidic device.

The one or more connecting ports can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, connecting ports. The microfluidic device can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, connecting ports. The one or more connecting ports can comprise an array n₁×n₂ connecting ports. One dimensionality of the array (e.g., n₁ or n₂) can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, connecting ports.

The number of connecting ports for directing droplets to a microfluidic channel can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, connecting ports. The number of connecting ports for directing droplets to a reaction chamber can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, connecting ports. A connecting port can be for directing droplets to a number of microfluidic channel or device, such as 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, microfluidic channels or devices.

Microfluidic Channels and Reaction Chambers

One or more microfluidic channels and/or one or more reaction chambers can be formed in the space surrounded by the first substrate, the second substrate, and the spacer layer. One or more microfluidic channels and/or one or more reaction chambers can be formed in the space surrounded by the first substrate, the dielectric layer, the first hydrophobic coating, the second substrate, the second electrodes, the second hydrophobic coating, and/or the spacer layer.

The microfluidic device can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, microfluidic channels. The microfluidic device can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, reaction chambers. The microfluidic device can comprise an array m₁×m₂ reaction chambers. One dimensionality of the array (e.g., m₁ or m₂) can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, reaction chambers. The number of microfluidic channels connected to a reaction chamber can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values, microfluidic channels.

### Sealing

In some embodiments, the method comprises sealing the microfluidic device or a microfluidic channel thereof and/or the surface of the microfluidic device or a microfluidic channel thereof with a first substrate (See FIGS. 2B-2C for an example). Referring to FIG. 2A, a microfluidic device can comprise a first substrate (e.g., glass, PDMS, or PCB), one or more first electrodes (e.g., Au, Cr, or indium tin oxide (ITO)) in contact with the first substrate, a dielectric layer in contact with the first substrate and the first electrodes, and a first hydrophobic coating in contact with the first dielectric layer. The microfluidic device can comprise a spacer layer in contact with the first substrate, the first dielectric layer, and the first hydrophobic layer. The microfluidic device can be sealed using a sealing component to form a sealed microfluidic device as shown in FIGS. 2B-2C. The sealing component can be secured to the remainder of the sealed microfluidic device using, for example, a clamp or holder. The sealing component can comprise a second substrate (e.g., glass, PDMS, or PCB), one or more second electrodes (e.g., Au, Cr, or indium tin oxide (ITO)) in contact with the second substrate and a second hydrophobic coating, and the second hydrophobic coating. In the sealed microfluidic device, the spacer layer can be in contact with the first substrate, the first dielectric layer, the first hydrophobic layer, the second substrate, the one or more second electrodes, and/or the second hydrophobic coating.

### Droplets

In some embodiments, the first liquid comprises an aqueous solution (or an aqueous phase). The second liquid can comprise an oil (or an oil phase). The second liquid can comprise a surfactant. In some embodiments, the first liquid comprises an oil (or an oil phase). The first liquid can comprise a surfactant. The second liquid can comprise an aqueous solution (or an aqueous phase). In some embodiments, generating and directly loading the first plurality of droplets comprises generating and directly loading the first plurality of droplets into the second liquid contained in the microfluidic device or a microfluidic channel thereof, thereby forming a first plurality of water-in-oil emulsions (See FIGS. 2A and 3 for examples) or oil-in-water emulsions.

In some embodiments, a size of one, at least one, or each, of the first plurality of droplets is substantially the same as a size of the microfluidic channel. The size of one, at least one, or each, of the first plurality of droplets and the size of the microfluidic channel can be within one order of magnitude of each other. The size of one, at least one, or each, of the first plurality of droplets can comprise a diameter, or a radius, of the droplet of the first plurality of droplets. A size of one, at least one, or each, of the first plurality of droplets can be, be about, be at least, or be at most, 0.000006 m, 0.000007 m, 0.000008 m, 0.000009 m, 0.00001 m, 0.00002 m, 0.00003 m, 0.00004 m, 0.00005 m, 0.00006 m, 0.00007 m, 0.00008 m, 0.00009 m, 0.0001 m, 0.0002 m, 0.0003 m, 0.0004 m, 0.0005 m, 0.0006 m, 0.0007 m, 0.0008 m, 0.0009 m, 0.001 m, 0.002 m, 0.003 m, 0.004 m, 0.005 m, or a number or a range between any two of these values. The size of the microfluidic channel can comprise a width and/or a height of the microfluidic channel. The size of the microfluidic channel can comprise a diameter and/or a radius of a cross section of the microfluidic channel. A size of the microfluidic channel can be, be about, be at least, or be at most, 0.000006 m, 0.000007 m, 0.000008 m, 0.000009 m, 0.00001 m, 0.00002 m, 0.00003 m, 0.00004 m, 0.00005 m, 0.00006 m, 0.00007 m, 0.00008 m, 0.00009 m, 0.0001 m, 0.0002 m, 0.0003 m, 0.0004 m, 0.0005 m, 0.0006 m, 0.0007 m, 0.0008 m, 0.0009 m, 0.001 m, 0.002 m, 0.003 m, 0.004 m, 0.005 m, or a number or a range between any two of these values.

The number of droplets generated and/or directly loaded (e.g., onto a microfluidic device or chip) can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, or a number or a range between any two of these values.

In some embodiments, one of the first plurality of droplets (and/or the second plurality of droplets) has a volume of from about 1 picoliter (pl) to about 1 nanoliter (nl). The volume of one, at least one, or each of the first plurality of droplets (and/or the second plurality of droplets) can be, be about, be at least, or be at most, 1 pl, 2 pl, 3 pl, 4 pl, 5 pl, 6 pl, 7 pl, 8 pl, 9 pl, 10 pl, 20 pl, 30 pl, 40 pl, 50 pl, 60 pl, 70 pl, 80 pl, 90 pl, 100 pl, 200 pl, 300 pl, 400 pl, 500 pl, 600 pl, 700 pl, 800 pl, 900 pl, 1000 pl, or a number or a range between any two of these values. The volume of one, at least one, or each of the first plurality of droplets (and/or the second plurality of droplets) can be, be about, be at least, or be at most, 1 nl, 2 nl, 3 nl, 4 nl, 5 nl, 6 nl, 7 nl, 8 nl, 9 nl, 10 nl, 20 nl, 30 nl, 40 nl, 50 nl, 60 nl, 70 nl, 80 nl, 90 nl, 100 nl, 200 nl, 300 nl, 400 nl, 500 nl, 600 nl, 700 nl, 800 nl, 900 nl, 1000 nl, or a number or a range between any two of these values.

The number of first plurality of droplets (and/or the second plurality of droplets) generated and/or loaded with an identical volume can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, or a number or a range between any two of these values. The number of first plurality of droplets (and/or the second plurality of droplets) generated and/or loaded with different volumes can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, or a number or a range between any two of these values.

### Analyzing Droplets

In some embodiments, analyzing the manipulated droplets comprises performing gene expression analysis, genotyping, real time polymerase chain reaction (PCR), digital PCR, targeted sequencing, single-cell genomics analysis, sample identification, Ag-genomics analysis, single cell analysis, single-cell proteomics analysis, single cell messenger ribonucleic acid (mRNA) sequencing, microRNA analysis, single cell deoxyribonucleic acid (DNA) sequencing, next generation sequencing, single cell targeted gene expression, RNA sequencing, single cell functional genomics, nucleic acid absolute quantification, copy number variation determination, loss of heterozygosity analysis, genetic alteration or modification detection, rare sequence or mutation detection, genome edit detection, drug metabolism analysis, or a combination thereof. In some embodiments, analyzing the manipulated droplets or contents thereof comprises obtaining mass spectrums of the manipulated droplets or contents thereof.

In some embodiments, one, at least one, or each, of the first plurality of droplets comprises a sample. In some embodiments, one, at least one, or each, of the second plurality of droplets comprises a sample. In some embodiments, one, at least one, or each, of the first plurality of droplets comprises a reagent. In some embodiments, one, at least one, or each, of the second plurality of droplets comprises a reagent. In some embodiments, one, at least one, or each, of the first plurality of droplets comprises a sample, and one, at least one, or each, of the second plurality of droplets comprises a reagent. In some embodiments, one, at least one, or each, of the first plurality of droplets comprises a reagent, and one, at least one, or each, of the second plurality of droplets comprises a sample.

In some embodiments, one, at least one, or each, of the first plurality of droplets potentially comprises an analyte, and one, at least one, or each, of the second plurality of droplets comprises one or more reaction partners of the analyte in the sample. In some embodiments, one, at least one, or each, of the first plurality of droplets comprises an analyte, and one, at least one, or each, of the second plurality of droplets potentially comprises one or more reaction partners of the analyte in the sample. In some embodiments, one, at least one, or each, of the first plurality of droplets comprises a reagent, and one, at least one, or each of the second plurality of droplets comprises a cell. In some embodiments, one, at least one, or each, of the first plurality of droplets comprises a cell, and one, at least one, or each of the second plurality of droplets comprises a reagent. In some embodiments, manipulating the first plurality of droplets comprises performing a reaction on the content of the sample contained, or a portion thereof, in one, at least one, or each, of the first plurality of droplets using a reagent.

### Barcoding Reagent

The reagent can comprise a barcoding reagent. The barcoding reagent can comprise a bead. The barcoding reagent can comprise a plurality of barcodes. The bead can comprise the plurality of barcodes. The plurality of barcodes can be attached to the bead. The plurality of barcodes can be reversibly attached to the bead. The plurality of barcodes can be released from the bead using a stimulus. The stimulus can comprise a chemical stimulus, a physical stimulus, a biological stimulus, a thermal stimulus, a magnetic stimulus, an electric stimulus, a light stimulus, or a combination thereof.

One, at least one, or each of the plurality of barcodes can comprise a molecular label, a cell label, a first target binding sequence, and/or a universal sequence. The molecular label can be 2-100 nucleotides in length. The molecular label can be, be about, be at least, or be at most, 2, 3, 4, 5, 6, 7, 8, 9, 10, 20, 30, 40, 50, 60, 70, 80, 90, 100, or a number or a range between any two of these values. The cell label can be 2-100 nucleotides in length. The cell label can be, be about, be at least, or be at most, 2, 3, 4, 5, 6, 7, 8, 9, 10, 20, 30, 40, 50, 60, 70, 80, 90, 100, or a number or a range between any two of these values. The first target binding sequence can be 2-100 nucleotides in length. The first target binding sequence can be, be about, be at least, or be at most, 2, 3, 4, 5, 6, 7, 8, 9, 10, 20, 30, 40, 50, 60, 70, 80, 90, 100, or a number or a range between any two of these values. The universal sequence can be 2-100 nucleotides in length. The universal sequence can be, be about, be at least, or be at most, 2, 3, 4, 5, 6, 7, 8, 9, 10, 20, 30, 40, 50, 60, 70, 80, 90, 100, or a number or a range between any two of these values.

Two barcodes of the plurality of barcodes can comprise cell labels with an identical cell label sequence. Cell labels of two barcodes of different barcoding reagents can comprise different cell label sequences. Two barcodes of the plurality of barcodes can comprise molecular labels with different molecular label sequences. Molecular labels of two barcodes of different barcoding reagents can comprise an identical molecular label sequence. The first target binding sequences can comprise a poly(dT) sequence. The first target binding sequence can comprise a repeat sequence of A, T, G, or C. The repeat sequence can comprise AA, TT, GG, or CC.

The barcoding reagent can comprise a plurality of oligonucleotides or polynucleotides each with a second target binding sequence. The second target binding sequences comprises a poly(dT) sequence. The bead can comprise the plurality of oligonucleotides or polynucleotides. The plurality of oligonucleotides or polynucleotides can be attached to the bead. The plurality of oligonucleotides or polynucleotides can be reversibly attached to the bead. The plurality of oligonucleotides or polynucleotides can be released from the bead using a stimulus. The second target binding sequence can be 2-40 nucleotides in length.

### Sample

In some embodiments, the sample comprises a clinical sample, a biological sample, a chemical sample, a soil sample, an air sample, an environmental sample, a cell culture sample, a bone marrow sample, a rainfall sample, a fallout sample, a sewage sample, a ground water sample, an abrasion sample, an archaeological sample, a food sample, a blood sample, a serum sample, a plasma sample, a urine sample, a stool sample, a semen sample, a lymphatic fluid sample, a cerebrospinal fluid sample, a nasopharyngeal wash sample, a sputum sample, a mouth swab sample, a throat swab sample, a nasal swab sample, a bronchoalveolar lavage sample, a bronchial secretion sample, a milk sample, an amniotic fluid sample, a biopsy sample, a cancer sample, a tumor sample, a tissue sample, a cell sample, a cell culture sample, a cell lysate sample, a virus culture sample, a nail sample, a hair sample, a skin sample, a forensic sample, an infection sample, a nosocomial infection sample, a production sample, a drug preparation sample, a biological molecule production sample, a deoxyribonucleic acid (DNA) sample, a protein sample, a sample, a carbohydrate sample, a metabolite sample, a space sample, an extraterrestrial sample or a combination thereof.

In some embodiments, an analyte or a potential analyte comprises one or more of proteins, nucleic acids, lipids, carbohydrates, chemicals, cells, or a combination thereof. In some embodiments, one or more reaction partners and/or one or more potential reaction partners comprise one or more of proteins, nucleic acids, lipids, carbohydrates, chemicals, cells, or a combination thereof. In some embodiments, an analyte, a potential analyte, one or more reaction partners, and/or one or more potential reaction partners comprise drugs, enzymes, antibodies, immunogens, antigens, metabolites, antibiotics, chemicals, microbial cells, or a combination thereof. In some embodiments, one or more potential reaction partners of the analyte comprise one or more potential substrates of an enzyme, and the analyte comprises an enzyme. The enzyme can be capable of catalyzing one substrate of the one or more potential substrates to a product. In some embodiments, the one or more potential reaction partners of the analyte comprise one or more enzymes potentially capable of catalyzing a substrate to a product, and the analyte comprises the substrate. One enzyme of the one or more enzymes potentially capable of catalyzing the substrate to the product can be capable of catalyzing the substrate to the product. The substrate can be a drug, and the enzyme can be capable of metabolizing the drug to the product.

In some embodiments, analytes and/or potential reaction partners of the analytes comprise different DNA constructs, a first plasmid, enzymes and/or cells, and the different DNA constructs together with the first plasmid, the enzymes and/or the cells assemble the DNA constructs into second plasmids capable of transforming the cells. An analyte can comprise a first chemical, one or more potential reaction partners of the analyte can comprise a second chemical, and the first chemical and the second chemical react to form one or more products. AN analyte and/or one or more potential reaction partners of the analyte can comprise a DNA molecule and drugs that interact with the DNA molecule, respectively. An analyte and/or one or more potential reaction partners of the analyte can comprise a protein molecule and drugs that interact with the protein molecule, respectively.

In some embodiments, at least two of the droplets from the first plurality of droplets and/or the second plurality of droplets comprise a potential reaction partner at different concentrations. The number of droplets of the first plurality of droplets and/or the second plurality of droplets with a potential reaction partner at different concentrations can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values. At least two of the droplets from the first plurality of droplets and/or the second plurality of droplets can comprise a potential reaction partner at an identical concentration. The number of droplets of the first plurality of droplets and/or the second plurality of droplets with a potential reaction partner at an identical concentration can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values.

At least two of the droplets from the first plurality of droplets and/or the second plurality of droplets can comprise an analyte in different concentrations. The first plurality of droplets and/or the second plurality of droplets can comprise an analyte at different concentrations. The number of different concentrations can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values. At least two of the droplets from the first plurality of droplets and/or the second plurality of droplets can comprise an analyte at an identical concentration. The number of droplets of the first plurality of droplets and/or the second plurality of droplets with an identical concentration can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, or a number or a range between any two of these values.

At least two of the droplets from the first plurality of droplets and/or the second plurality of droplets can comprise different buffer conditions. The first plurality of droplets and/or the second plurality of droplets can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, different buffer conditions

At least two of the droplets from the first plurality of droplets and/or the second plurality of droplets can comprise an identical buffer condition. The number of droplets of the first plurality of droplets and/or the second plurality of droplets with an identical buffer condition can be, be about, be at least, or be at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values.

The first plurality of droplets and/or the second plurality of droplets can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, analytes and/or potential analytes. The first plurality of droplets and/or the second plurality of droplets can comprise, comprise about, comprise at least, or comprise at most, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, or a number or a range between any two of these values, reaction partners and/or potential reaction partners.

### Contactless Delivery

In some embodiments, contactless delivery comprises motion-controlled pin printing, nozzle-free printing (laser-induced forward transfer (LIFT) and acoustic), inkjet printing (piezoelectric and thermal), electrospray deposition (ESD), electrohydrodynamic (EHD) printing, and extrusion printing (pneumatic, piston, and screw), or a combination thereof.

Contactless droplet deposition methodologies can be subdivided into various groups including motion-controlled pin printing, nozzle-free printing (laser-induced forward transfer (LIFT) and acoustic), inkjet printing (piezoelectric and thermal), electrospray deposition (ESD), electrohydrodynamic (EHD) printing, and extrusion printing (pneumatic, piston, and screw).

A motion controlled non-contact pin printer accelerates conventional split pins towards a substrate, stopping abruptly before contact. Momentum drives fluid out of the pin forming a liquid bridge between the pin and substrate. As the pin is retracted the bridge pinches off leaving a droplet on the surface. A variation on this method utilizes a scanning probe microscope (SPM) for droplet deposition. The SPM may have a fluid reservoir connected to the tip and the tip may have various shapes and features including a central opening.

Laser-induced forward transfer (LIFT) is also termed laser-assisted printing, laser printing, and laser writing. In LIFT a pulsed laser beam is scanned over an absorbing substrate. The laser pulse produces local evaporation resulting in bubbles that propel droplets.

Acoustic printing is the generation of an acoustic focal plane at the air-liquid interface that results in droplet ejection. This can be accomplished with an acoustic horn positioned under a fluid reservoir or with a piezoelectric substrate with interdigitated ring structures for focusing acoustic waves.

Piezoelectric inkjet printers produce acoustic waves that force liquid through a nozzle that forms droplets. Thermal inkjet printers evaporate a small amount of liquid near a heating element which expels droplets from the printing head.

In electrospray deposition (ESD), an electric field is generated between a capillary and substrate. The electric field propels droplets from a nozzle at the end of the capillary. A dielectric mask positioned between the capillary and substrate attracts droplets through holes in the mask to form a droplet array.

Electrohydrodynamic (EHD) printers deposit drops from a metal coated capillary nozzle. A voltage applied between the nozzle and substrate produces an EHD effect that propels droplets from the nozzle and onto the substrate. Another droplet jetting technique includes coaxially arranged needles that eject droplets due to an EHD process.

Extrusion printers typically dispense continuous flows by applying mechanical or pneumatic pressure to a syringe. Droplet jetting can be achieved with careful control over the nozzle geometry, wetting properties of the nozzle, and applied pressure.

### EXAMPLES

Some aspects of the embodiments discussed above are disclosed in further detail in the following examples, which are not in any way intended to limit the scope of the present disclosure.

### Example 1

### Contactless Droplet Loading

This example demonstrates loading droplets onto a microfluidic device.

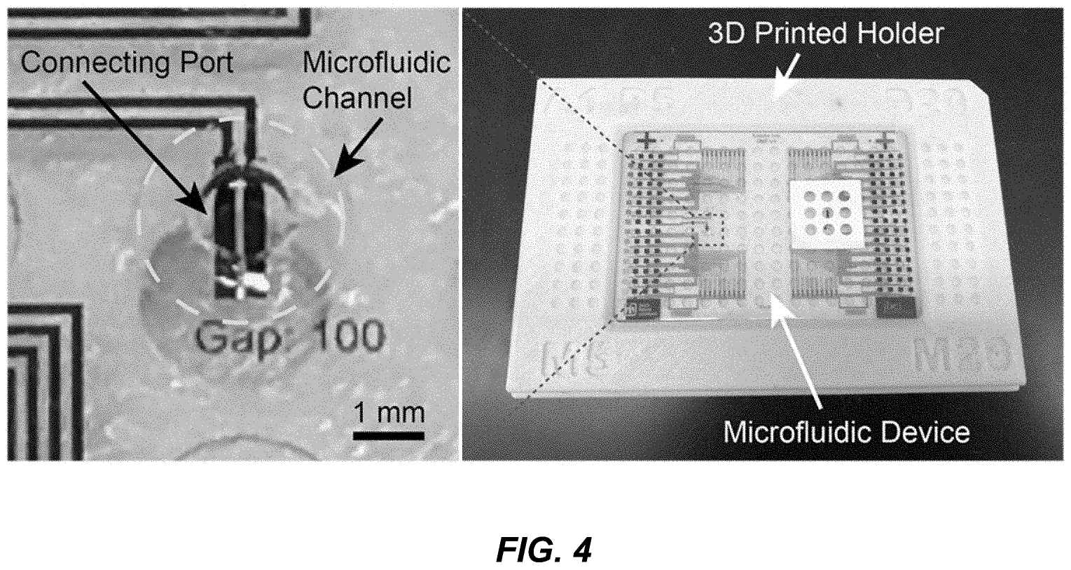

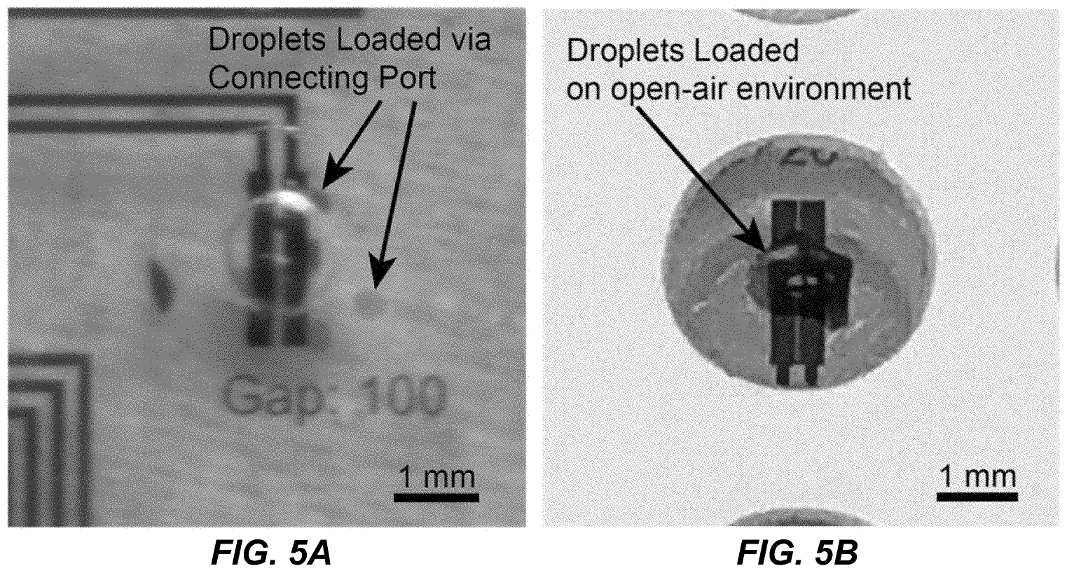

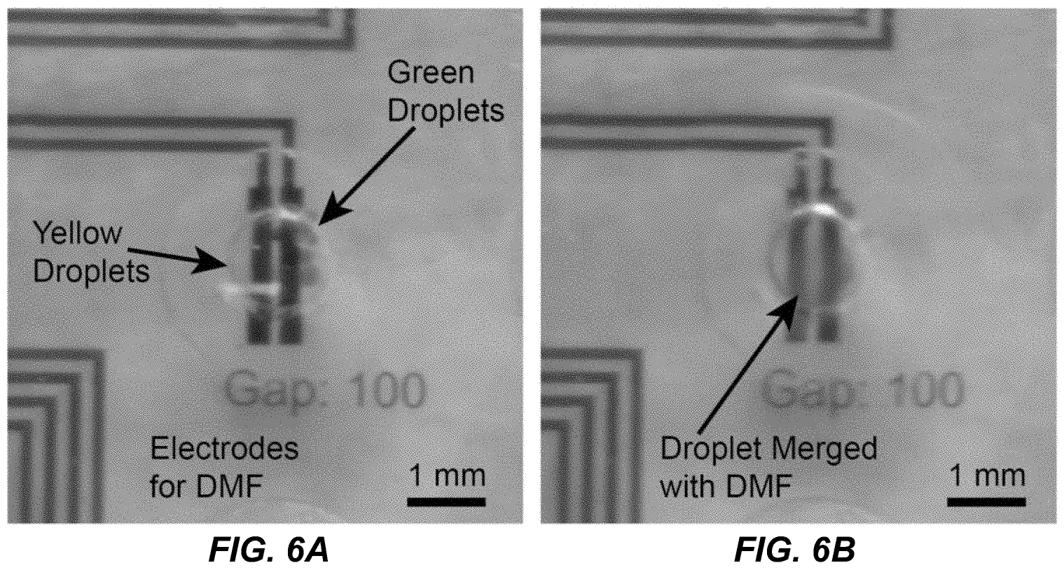

Aqueous samples were loaded onto a pre-sealed microfluidic device via connecting ports (FIG. 3). FIG. 4 shows the fabricated microfluidic chip with a three-dimensional (3D) printed holder to align the location of the connecting ports to match with the jetting or dispensing locations. Droplets were directly loaded into the microfluidic channel with the contactless delivery or jetting process from an acoustic printer (FIGS. 5A-5B). Loaded droplets were separated from each other when the channel was pre-filled with an oil phase with a surfactant (FIG. 5A), while droplets were immediately merged when loaded onto a channel with open air environment without an oil (FIG. 5B). Three different volumes (25 nl, 50 nl, and 100 nl) of samples with different colors were loaded via a connecting port. Oil also prevented the loaded aqueous samples to be evaporated. Loaded droplets can be manipulated with microfluidic methods such as pressure-based, flow-based, electric field-based, and/or digital microfluidic (DMF) manipulations. FIGS. 6A-6B show the successful demonstration of merging water-in-oil droplets with digital microfluidics (DMF) manipulation by applying voltage to DMF electrodes.

Altogether, these data indicate contactless delivery can be used to generate and directly load droplets onto a microfluidic device and the loaded droplets can be manipulated, such as merged.

### Example 2

### A Microfluidic Device for Contactless Droplet Loading

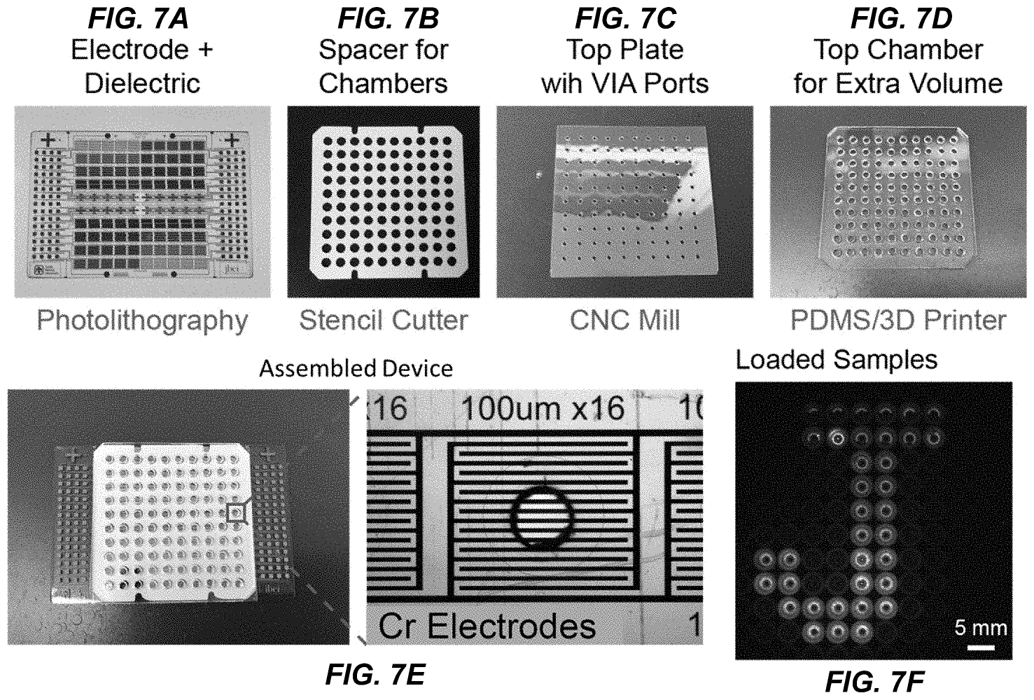

FIGS. 7A-7F are non-limiting exemplary photographs showing components of a microfluidic device. FIG. 7E is a non-limiting exemplary photograph showing a microfluidic device assembled from, bottom to top, an electrode and dielectric layer (FIG. 7A), a spacer for chambers (FIG. 7B), a top chamber for extra volume (FIG. 7D), and a top plate with connecting ports (FIG. 7). FIG. 7F is a non-limiting exemplary photograph showing samples loaded to a microfluidic device through connecting ports.

### Terminology

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. (canceled)

2. (canceled)

3. A method for loading droplet and analyzing contents thereof, comprising:
generating and directly loading a first plurality of droplets comprising a first liquid onto a surface of a microfluidic device or a microfluidic channel thereof, or into a second liquid contained in the microfluidic device or a microfluidic channel thereof, using contactless delivery;
manipulating the first plurality of droplets; and
analyzing manipulated droplets of the first plurality of droplets, or contents thereof, thereby analyzing the contents of the first plurality of droplets.

4. (canceled)

5. (canceled)

6. The method of claim 3, wherein generating and directly loading the first plurality of droplets comprises generating and directly loading the first plurality of droplets onto the surface of the microfluidic device or a microfluidic channel thereof, or into the second liquid contained in the microfluidic device or a microfluidic channel thereof, through one or more connecting ports in a second substrate of the microfluidic device, optionally wherein each of the one or more connecting ports corresponds to and/or is for directing one or more of the first plurality of droplets to a first location of the microfluidic device and/or one of a first plurality of microfluidic channels of the microfluidic device.

7. The method of claim 6, wherein the one or more connecting ports comprise at least 10 connecting ports or an array of at least 10×10 connecting ports.

8.-11. (canceled)

12. The method of claim 3, wherein generating and directly loading the first plurality of droplets comprise generating and directly loading the first plurality of droplets to one or more first locations of each of a first plurality of microfluidic channels of the microfluidic device comprising the second liquid.

13. The method of claim 3, wherein generating and directly loading the first plurality of droplets comprise generating and directly loading the first plurality of droplets into the second liquid contained in the microfluidic device or a microfluidic channel thereof, thereby forming a first plurality of water-in-oil emulsions or oil-in-water emulsions.

14. The method of claim 3, wherein the first liquid comprises an aqueous solution and the second liquid comprises an oil and a surfactant, or wherein the first liquid comprises an oil and a surfactant and the second liquid comprises an aqueous solution.

15. The method of claim 3, wherein generating and directly loading the first plurality of droplets comprises generating and directly loading the first plurality of droplets from a source remote from the microfluidic device.

16. The method of claim 3, wherein a size of one, at least one, or each, of the first plurality of droplets is substantially the same as a size of the microfluidic channel and/or wherein the size of one, at least one, or each, of the first plurality of droplets and the size of the microfluidic channel are within one order of magnitude of each other, optionally wherein the size of one, at least one, or each, of the first plurality of droplets comprises a diameter of the droplet of the first plurality of droplets, and optionally wherein the size of the microfluidic channel comprises a width and/or a height of the microfluidic channel.

17-22. (canceled)

23. The method of claim 3, comprising sealing the microfluidic device or a microfluidic channel thereof and/or the surface of the microfluidic device or a microfluidic channel thereof with a second substrate.

24. The method of claim 3, wherein the contactless delivery comprises motion-controlled pin printing, nozzle-free printing (laser-induced forward transfer (LIFT) and acoustic), inkjet printing (piezoelectric and thermal), electrospray deposition (ESD), electrohydrodynamic (EHD) printing, and extrusion printing (pneumatic, piston, and screw), or a combination thereof.

25. The method of claim 3, wherein manipulating the first plurality of droplets comprises manipulating the first plurality of droplets using a pressure-driven manipulation and/or an electric field-based manipulation (electrowetting on dielectric (EWOD) or dielectrophoresis (DEP)).

26. (canceled)

27. (canceled)

28. The method of claim 3, wherein manipulating the first plurality of droplets comprises merging two of the first plurality of droplets, and/or wherein manipulating the first plurality of droplets comprises merging one, at least one, or each, of the first plurality of droplets with a droplet of a second plurality of droplets.

29. (canceled)

30. The method of claim 28,
wherein one, at least one, or each, of the first plurality of droplets potentially comprises an analyte, and wherein one, at least one, or each, of the second plurality of droplets comprises one or more reaction partners of the analyte in the sample, or
wherein one, at least one, or each, of the first plurality of droplets comprises an analyte, and wherein one, at least one, or each, of the second plurality of droplets potentially comprises one or more reaction partners of the analyte in the sample.

31. (canceled)

32. The method of claim 28,
wherein one, at least one, or each, of the first plurality of droplets comprises a reagent, and wherein one, at least one, or each of the second plurality of droplets comprises a cell, or
wherein one, at least one, or each, of the first plurality of droplets comprises a cell, and wherein one, at least one, or each of the second plurality of droplets comprises a reagent.

33. (canceled)

34. (canceled)

35. The method of claim 3, comprising loading a second plurality of droplets onto the surface of the microfluidic device or a microfluidic channel thereof, or into the second liquid contained in the microfluidic device or a microfluidic channel thereof.

36. (canceled)

37. (Canceled).

38. The method of claim 3, wherein manipulating the first plurality of droplets comprises manipulating the content of one, at least one, or each, of the first plurality of droplets, or wherein manipulating the first plurality of droplets comprises performing a reaction on the content of the sample contained, or a portion thereof, in one, at least one, or each, of the first plurality of droplets using a reagent.

39. (canceled)

40. (canceled)

41. The method of claim 3, wherein analyzing the manipulated droplets comprises performing gene expression analysis, genotyping, real time polymerase chain reaction (PCR), digital PCR, targeted sequencing, single-cell genomics analysis, sample identification, Ag-genomics analysis, single cell analysis, single-cell proteomics analysis, single cell messenger ribonucleic acid (mRNA) sequencing, microRNA analysis, single cell deoxyribonucleic acid (DNA) sequencing, next generation sequencing, single cell targeted gene expression, RNA sequencing, single cell functional genomics, nucleic acid absolute quantification, copy number variation determination, loss of heterozygosity analysis, genetic alteration or modification detection, rare sequence or mutation detection, genome edit detection, drug metabolism analysis, or a combination thereof.

42. The method of claim 3, wherein analyzing the manipulated droplets or contents thereof comprises obtaining mass spectrums of the manipulated droplets or contents thereof.

43-45. (canceled)

46. The method of claim 30, wherein the analyte and/or the one or more potential reaction partners comprise drugs, proteins, enzymes, antibodies, immunogens, antigens, metabolites, antibiotics, nucleic acids, lipids, carbohydrates, chemicals, cells, microbial cells, or a combination thereof.

47.-57. (canceled)

58. The method of claim 3, wherein the microfluidic device comprises a first substrate, one or more first electrodes in contact with the first substrate, a dielectric layer in contact with the first substrate and the first electrodes, a first hydrophobic coating in contact with the first dielectric layer, a second substrate, one or more second electrodes in contact with the second substrate and a second hydrophobic coating, the second hydrophobic coating, a spacer layer in contact with the first substrate, the first dielectric layer, the first hydrophobic layer, the second substrate, the one or more second electrodes, and/or the second hydrophobic coating.

59. (canceled)
